(19) United States
(12) Patent Application Publication
(10) Pub. No.: US 2024/0379278 A1
(43) Pub. Date: Nov. 14, 2024

(54) PRINTED CIRCUIT BOARD BASED WINDING STRUCTURE FOR INDUCTORS

(71) Applicant: Delta Electronics, Inc., Taipei (TW)

(72) Inventors: Anup ANURAG, Research Triangle Park, NC (US); Peter BARBOSA, Research Triangle Park, NC (US)

(73) Assignee: Delta Electronics, Inc., Taipei (TW)

(21) Appl. No.: 18/316,219

(22) Filed: May 11, 2023

(51) Int. Cl. H01F 27/28; H01F 27/29

(52) U.S. Cl. CPC H01F 27/2804; H01F 27/29; H01F 27/266; H01F 2027/2814

(57) ABSTRACT

A reliable, potting free, and partial discharge free PCB-based inductor is provided. In one aspect, the PCB-based inductor includes an insulating planar board having a central through hole and conductive layers embedded in the insulating planar board. Each of the conductive layers is patterned to have a spiral shape around the central through hole and arranged in an annulus region having an annular radius. The conductive layers are arranged in a staggered pattern, such that the annular radius of the conductive layers increases from the centermost one of the conductive layers to the outermost ones of the conductive layers.

### RELATED APPLICATIONS

This application relates to U.S. Nonprovisional application Ser. No. 17/471,142, filed on Sep. 9, 2021, the entire contents of which are incorporated herein by reference for all purposes.

### TECHNICAL FIELD

The present disclosure relates to a printed circuit board (PCB) based planar winding structure for use in an inductor. More particularly, the present disclosure relates to a PCB-based planar winding structure for use in inductors for medium voltage applications.

### BACKGROUND

With the advancement of wide bandgap semiconductors, power electronic devices with high blocking voltages capable of switching at high frequencies have opened up new areas of applications and are becoming more common in the industry. These wide bandgap semiconductor-based converter systems find applications in power converters that includes but not limited to renewable energy integration, active filters, shore-to-ship power systems, and solid-state transformers. Solid-state transformers (SSTs) are considered the most lucrative solution to achieve all these requirements, because they can provide a direct power electronics interface from the medium voltage AC (MVac, 4.16 kV/13.8 kV grid) stage to the low voltage DC (LVdc, 400 V/800 V) stage. The major advantage of SSTs is that these SSTs eliminate the requirement of bulky conventional low-frequency transformers, which are replaced by high frequency magnetics and a power electronics interface. A typical connection from the MVac grid to a power electronics converter system requires a medium voltage inductor interface.

MV inductors have been used in the power system since its inception. Conventionally, these inductors are designed for high power applications, and most importantly are used extensively for low frequency applications. Because these inductors are used for low frequency currents, silicon steel material is used as the core material along with solid copper windings. With SiC devices, however, the converters are operated at high switching frequencies to minimize the size of the magnetic components. Not only does this result in a low frequency current in the inductor, but also a high switching frequency ripple. Conventional medium voltage inductors fail in this scenario.

A lot of research has been done predominantly in low voltage applications (i.e., <2 kV) to account for these high frequency losses. The use of litz wires provides a good solution for decreasing the high frequency winding losses, and various core materials like ferrite or nanocrystalline can be used to reduce the high frequency core losses. However, medium voltage inductors require additional insulation, and necessitates a partial discharge free operation (reliable and continuous operation). Achieving a good efficiency and a reasonable power density along with the medium voltage insulation requirement remain as a big challenge. Also, considering the cost and ease of manufacturing, PCB based solutions are typically preferred over conventional winding-based solutions, because they offer reliable and repeatable designs.

Various works have been done in the literature for medium voltage inductor design. Because high frequency medium voltage transformers have similar design criteria, they have also been included in the study. The major focus is on the insulation design of the inductors/transformers. The most basic method of achieving the required voltage insulation is by providing some distance between the windings and from layer-to-layer [Ref. 1]. In [Ref. 1], the medium voltage insulation between the winding and the core is achieved using a 3D printed bobbin. The layer-to-layer insulation is achieved by providing spacers between the layers as shown in FIG. 1. In this case, the voltage stress is handled by the air gap as well as the spacer. This method is simple and easy to implement but is not scalable to higher voltage. Also, it increases the volume of the inductor due to the large air gaps. It should be noted that instead of an air gap, an insulation material can also be used between the layers to reduce the spacing. However, such a structure does not offer a partial-discharge free operation to account for the air gaps between the windings.

Another method typically used for magnetics design is based on encapsulation or potting parts of the inductor using an encapsulating material. [Ref. 2] and [Ref. 3] provide a transformer/inductor design with this concept. A shielding layer may be added to the surface of this encapsulating structure to ensure that the electric field is limited within the encapsulant and thus the magnetic component can offer a partial discharge free behavior, as taught in [Ref. 4] and [Ref. 5]. However, in these structures, to achieve a partial discharge free operation, it is necessary to have an air-free space inside the encapsulating structure. This is rather difficult and unreliable to achieve especially when a multi-layer winding structure is used. FIG. 2 shows an example of these structures.

In [Ref. 6], a medium voltage transformer is designed where the primary and secondary windings are separately dry cast to provide the required insulation. This concept can also be used for inductors where the inductor winding is dry cast and is placed at a certain distance from the core.

Another method is showcased in [Ref. 7], where a medium voltage air core transformer is demonstrated. This concept can also be extended for air core inductors. In terms of insulation, this structure proves to be beneficial due to the absence of the core, which removes any restrictions for the winding to core insulation. While this is beneficial in terms of insulation design to a certain extent, it is not feasible to use air core-based inductors in various applications, due to its largely increased size and undirected magnetic fields, which is a consequence of the absence of core. Also, it is impractical to scale the concept for higher value of inductances. For these reasons, air core magnetics are typically not preferred in most applications.

In [Ref. 8], a high frequency planar PCB transformer with medium voltage isolation is demonstrated. A dielectric material with a high breakdown voltage is used to withstand the medium voltage between primary and secondary windings. To avoid arcing from the edge of the windings to the core, the core is encapsulated with an epoxy material, as well as moved away from the core to avoid partial discharge between the windings and the core. This structure, however, does not offer a partial discharge free operation at the interface of the low voltage and the medium voltage windings.

Typically, these structures can be dipped into oil to achieve the required partial discharge ratings, but since dry type magnetics is preferred in the medium voltage applications, dipping the magnetics into oil does not provide the most effective and reliable solution.

### REFERENCES

[Ref. 1] H. Zhao et al., “Physics-Based Modeling of Parasitic Capacitance in Medium-Voltage Filter Inductors,” IEEE Transactions on Power Electronics, vol. 36, no. 1, pp. 829-843, January 2021, doi: 10.1109/TPEL.2020.3003157.
[Ref. 2] D. Rothmund, T. Guillod, D. Bortis and J. W. Kolar, “99% Efficient 10 kV SiC-Based 7 kV/400 V DC Transformer for Future Data Centers,” IEEE Journal of Emerging and Selected Topics in Power Electronics, vol. 7, no. 2, pp. 753-767, June 2019, doi: 10.1109/JESTPE.2018.2886139.
[Ref. 3] D. Rothmund, T. Guillod, D. Bortis and J. W. Kolar, “99.1% Efficient 10 kV SiC-Based Medium-Voltage ZVS Bidirectional Single-Phase PFC AC/DC Stage,” IEEE Journal of Emerging and Selected Topics in Power Electronics, vol. 7, no. 2, pp. 779-797, June 2019, doi: 10.1109/JESTPE.2018.2886140.
[Ref. 4] H. Li, P. Yao, Z. Gao and F. Wang, “Medium Voltage Converter Inductor Insulation Design Considering Grid Requirements,” IEEE Journal of Emerging and Selected Topics in Power Electronics, vol. 10, no. 2, pp. 2339-2350 April 2022, doi: 10.1109/JESTPE.2021.3131602.
[Ref. 5] Q. Chen, R. Raju, D. Dong and M. Agamy, “High Frequency Transformer Insulation in Medium Voltage SiC enabled Air-cooled Solid-State Transformers,” 2018 IEEE Energy Conversion Congress and Exposition (ECCE), 2018, pp. 2436-2443, doi: 10.1109/ECCE.2018.8557849.
[Ref. 6] T. B. Gradinger, U. Drofenik and S. Alvarez, “Novel insulation concept for an MV dry-cast medium-frequency transformer,” 2017 19th European Conference on Power Electronics and Applications (EPE′17 ECCE Europe), 2017, pp. P.1-P.10, doi: 10.23919/EPE17ECCEEurope.2017.8099006.
[Ref. 7] P. Czyz, T. Guillod, F. Krismer, J. Huber and J. W. Kolar, “Design and Experimental Analysis of 166 kW Medium-Voltage Medium-Frequency Air-Core Transformer for 1:1-DCX Applications,” IEEE Journal of Emerging and Selected Topics in Power Electronics, doi: 10.1109/JESTPE.2021.3060506.
[Ref. 8] S. Mukherjee et al., “A High-Frequency Planar Transformer with Medium-Voltage Isolation,” 2021 IEEE Applied Power Electronics Conference and Exposition (APEC), 2021, pp. 2065-2070, doi: 10.1109/APEC42165.2021.9487061.

### SUMMARY

The present disclosure provides a reliable, potting free, partial discharge free at operating voltage, PCB-based solution, which can be manufactured easily with great repeatability and good performance.

In one aspect, the present disclosure provides a PCB-based inductor, including: an insulating planar board having a central through hole: a plurality of conductive layers embedded in the insulating planar board and stacked on top of each other, the conductive layers being electrically connected with each other through one or more buried vias, each of the conductive layers being patterned to have a spiral shape around the central through hole and arranged in an annulus region having an annular radius: a first terminal electrically coupled to outermost ones of the conductive layers; and a second terminal electrically coupled to a centermost one of the conductive layers; wherein the conductive layers are arranged in a staggered pattern.

In one embodiment, the staggered pattern is a concave staggered pattern.

In one embodiment, the concave staggered pattern is defined such that the annular radius of the conductive layers increases from the centermost one of the conductive layers to the outermost ones of the conductive layers.

In one embodiment, the PCB-based inductor further includes a winding extension protruding from an edge of the conductive layers.

In one embodiment, the second terminal is electrically coupled to the centermost one of the conductive layers through the winding extension.

In one embodiment, lateral sides of the winding extension are arranged in a concave staggered pattern, and wherein a frontal side of the winding extension is arranged in a convex staggered pattern.

In one embodiment, the conductive layers are spatially separated in a vertical direction.

In one embodiment, the PCB-based inductor further includes a magnetic core magnetically coupled to the conductive layers.

In one embodiment, the PCB-based inductor further includes a conducting or semiconducting layer coated on a surface of the magnetic core.

In one embodiment, the magnetic core is electrical connected to the first terminal through the conducting or semiconducting layer.

In another aspect, the present disclosure provides a medium voltage inductor assembly, including: a plurality of the PCB-based inductors discussed above: a bobbin structure that holds the PCB-based inductors; and a magnetic core assembly magnetically coupled to the PCB-based inductors.

In still another aspect, the present disclosure provides a medium voltage inductor assembly, including a plurality of the PCB-based inductor discussed above, wherein the first terminals of the PCB-based inductors are electrically connected to each other, and wherein the second terminals of the PCB-based inductors are electrically connected to each other.

In yet another aspect, the present disclosure provides a PCB-based inductor, including: an insulating planar board having a central through hole: a plurality of conductive layers embedded in the insulating planar board and stacked on top of each other, the conductive layers being electrically connected with each other through one or more buried vias, each of the conductive layers being patterned to have a spiral shape around the central through hole and arranged in an annulus region having an annular radius: a first terminal electrically coupled to outermost ones of the conductive layers; and a second terminal electrically coupled to a centermost one of the conductive layers; wherein the annular radius of the conductive layers increases from the centermost one of the conductive layers to the outermost ones of the conductive layers.

In one embodiment, the PCB-based inductor further includes a winding extension protruding from an edge of the conductive layers.

In one embodiment, the second terminal is electrically coupled to the centermost one of the conductive layers through the winding extension.

In one embodiment, lateral sides of the winding extension are arranged in a concave staggered pattern, and wherein a frontal side of the winding extension is arranged in a convex staggered pattern.

In a further aspect, the present disclosure provides a PCB-based inductor, including: an insulating planar board having a central through hole: a plurality of conductive layers embedded in the insulating planar board and stacked on top of each other, the conductive layers being electrically connected with each other through one or more buried vias, each of the conductive layers being patterned to have a spiral shape around the central through hole and arranged in an annulus region having an annular radius: a winding extension protruding from an edge of the conductive layers: a first terminal electrically coupled to outermost ones of the conductive layers; and a second terminal electrically coupled to a centermost one of the conductive layers through the winding extension; wherein the annular radius of the conductive layers increases from the centermost one of the conductive layers to the outermost ones of the conductive layers.

In one embodiment, lateral sides of the winding extension are arranged in a concave staggered pattern.

In one embodiment, a frontal side of the winding extension is arranged in a convex staggered pattern.

### BRIEF DESCRIPTION OF DRAWINGS

The present disclosure is better understood upon consideration of the following detailed description and the accompanying figures.

FIG. 1 illustrates a conventional transformer solution that achieves insulation by providing space between the windings and between the winding and the core.

FIG. 2 illustrates a conventional transformer solution with an encapsulant to seal the windings and a shielding layer on the encapsulant.

FIG. 3 illustrates a PCB-based medium voltage inductor in accordance with an embodiment of the present disclosure.

FIG. 4 illustrates an exemplary voltage gradient in one layer of the inductor of FIG. 3, when a 15 kV voltage is applied across electric terminals of the inductor.

FIGS. 5A, 5B, and 5C respectively illustrate a sectional view of the inductor of FIG. 3 along planes A, B, and C.

FIG. 6 illustrates a PCB-based medium voltage inductor in accordance with another embodiment of the present disclosure.

FIG. 7 illustrates a cross-sectional view of a medium voltage inductor that uses a bobbin structure to hold a plurality of PCB windings and a magnetic core assembly in accordance with an embodiment of the present disclosure.

FIG. 8 illustrates a medium voltage PCB-based inductor assembly including two identical PCB-based inductors connected in parallel in accordance with an embodiment of the present disclosure.

FIG. 9 illustrates an equivalent circuit for two parallelly connected PCB-based windings in accordance with an embodiment of the present disclosure.

FIGS. 10A and 10B respectively illustrate simulated results of electric field distribution for the winding layers of a PCB-based inductor arranged in “concave” and “convex” staggered patterns.

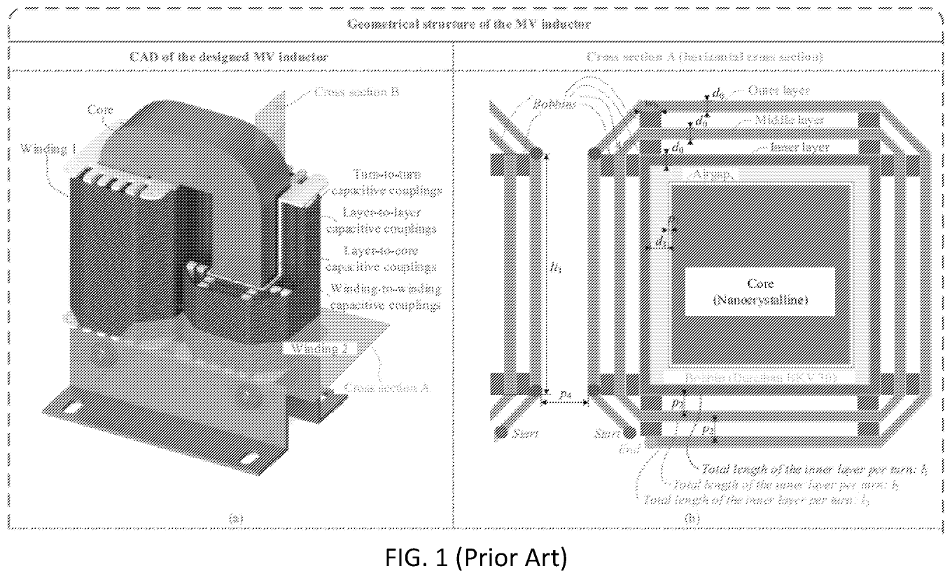

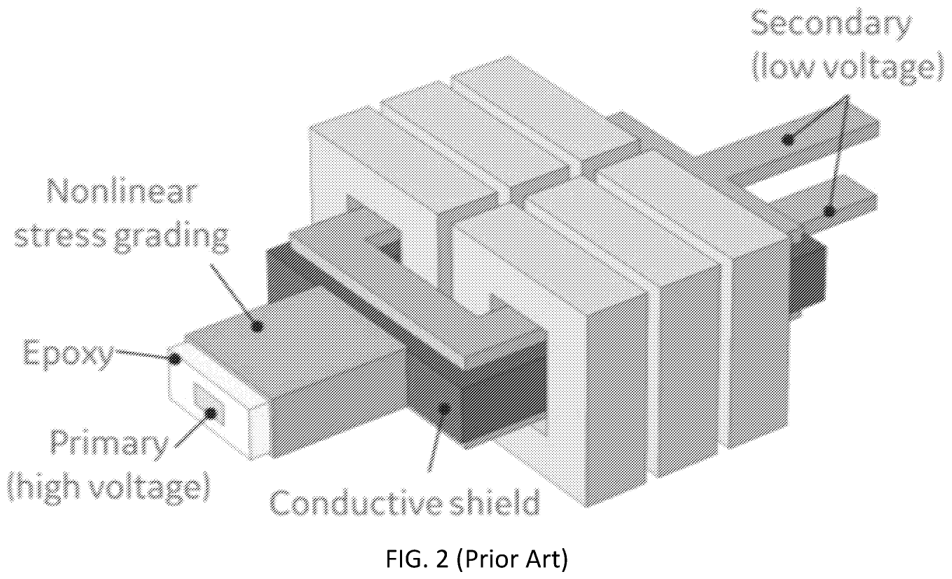

### DETAILED DESCRIPTION

The present disclosure is generally directed to a PCB-based medium voltage inductor, which offers a partial discharge free design without additional encapsulation. Embodiments of the present disclosure restrict the electric field on the surface of the PCB winding to less than the air breakdown voltage at operating voltage levels to create a partial discharge free operation. The magnetic core is tied to one of the terminals of the inductor to define the potential of the core, and thus shape the electric field at and/or near the surface of the PCB. It is to be understood that the PCB winding structure can be designed in any suitable manner to shape the electric field.

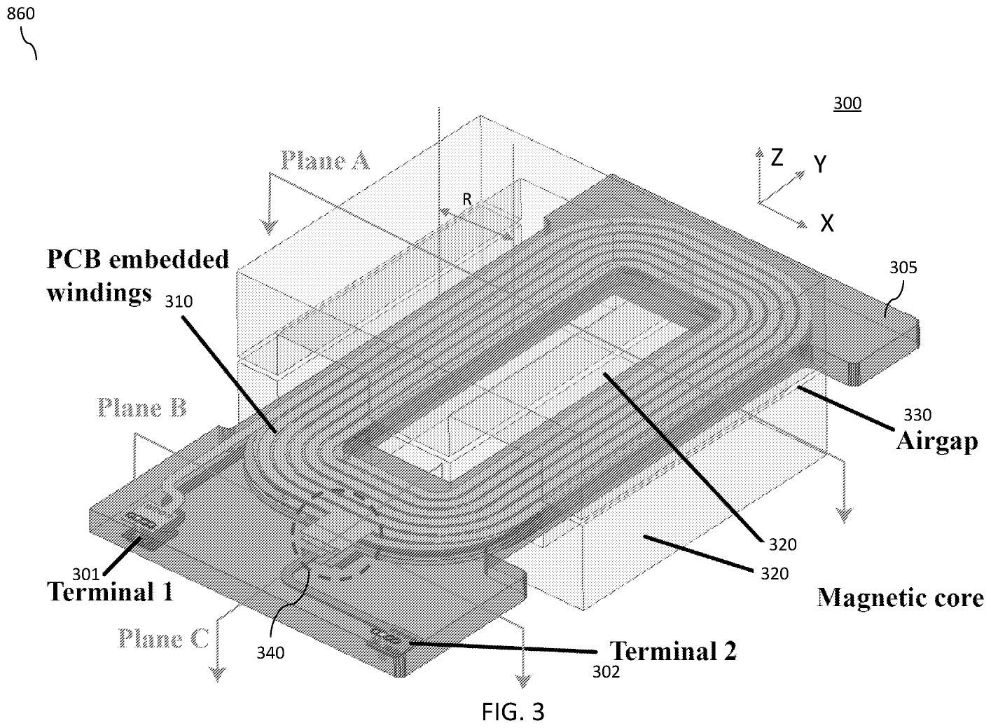

FIG. 3 illustrates a PCB-based medium voltage inductor 300 in accordance with an embodiment of the present disclosure. Windings 310 of inductor 300 are embedded inside a PCB 305, while a magnetic core 320 provides a path for the magnetic field to flow. In certain embodiments, windings 310 may be made of copper or any other suitable conductive material including a plurality of conductive layers that are embedded in PCB 305 and stacked on top of each other. The conductive layers are electrically connected with each other using buried vias. A small air gap 330 is required in magnetic core 320 to achieve the required inductance. A through hole is provided in PCB 305 to accommodate magnetic core 320.

Each conductive layer of windings 310 may be patterned to have a spiral shape on a horizontal plane having several revolutions, such that it winds around the through hole of PCB 305 at a continuously increasing or decreasing distance. In one embodiment, each spiral shaped conductive layer of windings 310 is confined within an oval or rectangular annulus region having an annulus radius.

First and second terminals 301 and 302 are provided to direct electric current into and out of windings 310. In one embodiment, first terminal 301 is electrically connected to the topmost and bottom most layers of windings 310, while second terminal 302 is electrically connected to the center most layer(s) of windings 310. Essentially, inductor 300 includes two windings 310 connected with each other in parallel.

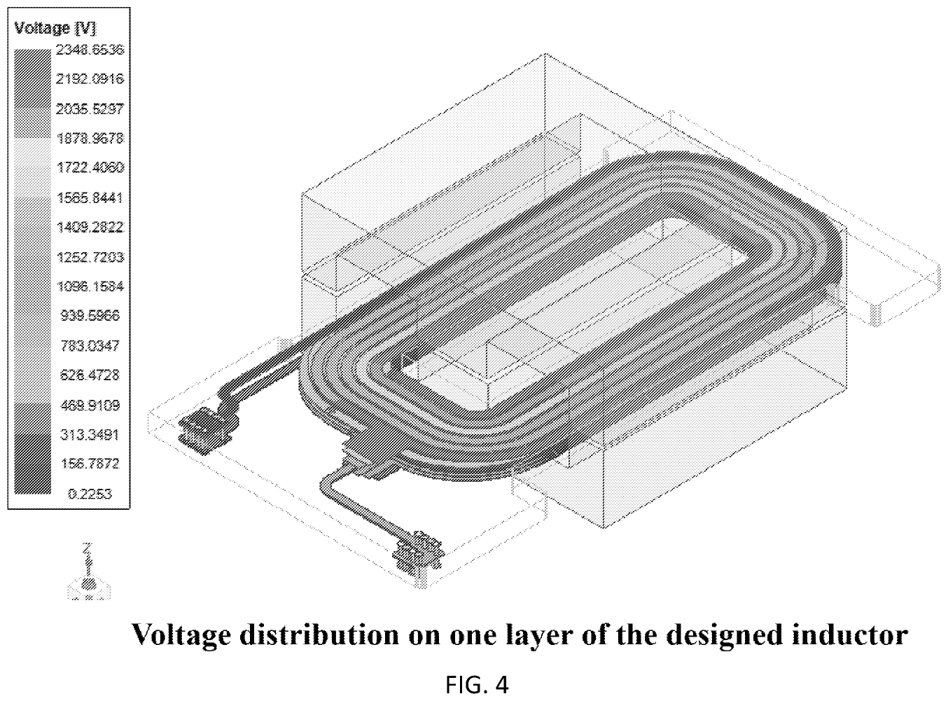

Depending on specific designs and/or requirements, PCB 305 can have any suitable shape and/or thickness. It should be noted that when a current/voltage is applied to inductor 300, the voltage will be distributed between windings 310, and thus forms a voltage gradient across the windings 310. FIG. 4 illustrates an exemplary voltage gradient in one layer of inductor 300 when a 15 kV voltage is applied across terminals 301 and 302.

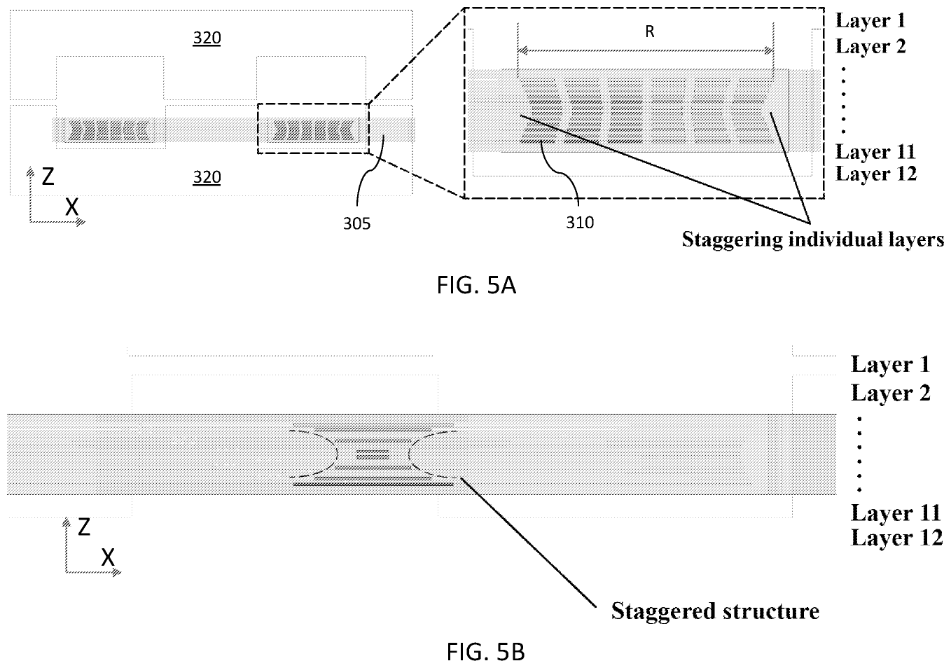

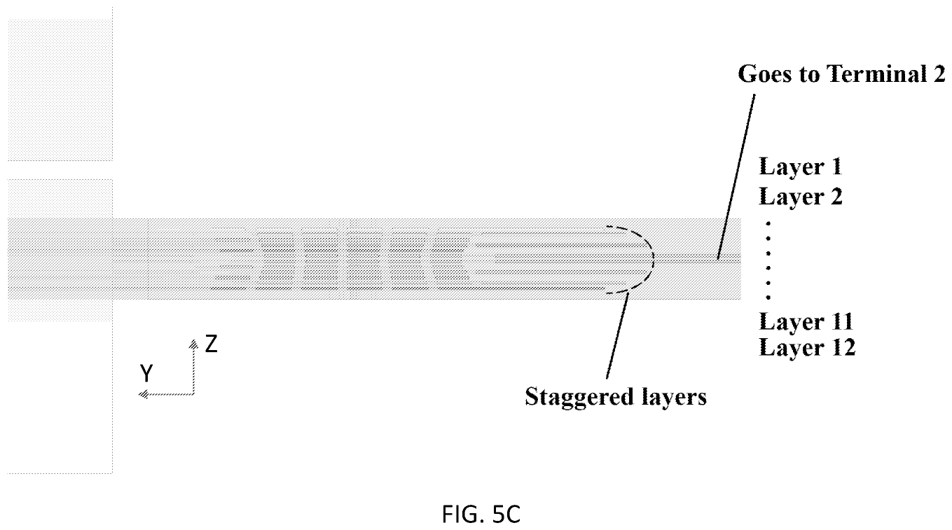

FIGS. 5A, 5B, and 5C respectively illustrate a sectional view of inductor 300 along planes A, B, and C in FIG. 3. As shown in FIG. 5A, windings 310 of inductor 300 are arranged in a specific “staggered” pattern to limit or shape the electric field inside, on, and/or near PCB 305, thereby offering a partial discharge free operation of the medium voltage inductor 300 without the need of any additional potting. In this embodiment, windings 310 include twelve conductive layers 1 through 12, which are arranged in a “concave” staggered pattern. That is, edges of the uppermost (e.g., layer 1) and lowermost (e.g., layer 12) layers of the conductive layers of windings 310 constitute a greater annulus radius R than that of the central layers (e.g., layers 6 and/or 7). In addition, each revolution of the spiral shaped conductive layers is generally aligned with each other, except that when viewed in a sectional view from the sides, conductive layers 1 through 12 appears to form a concave (e.g., “V” or “U”) shape. It is appreciated that any suitable quantity of conductive layers can be used depending on design choices. In addition, conductive layers 1 through 12 of windings 310 are spatially separated in the vertical direction (or the Z direction) from each other using the PCB material and are electrically connected at specific points using buried vias (to provide a continuous current path). These buried vias can be filled with an encapsulant material, such as epoxy, to avoid air bubbles inside the PCB material.

It is appreciated that the partial discharge free operation is made possible primarily because the voltage applied on first and second terminals 301 and 302 is distributed between windings 310, thereby forming a voltage gradient across windings 310. The staggered windings utilize this voltage gradient to shape the electric field inside and on the surface of PCB 305. The choice of the distance between the winding distances in the X direction is a design choice and can be changed depending on the requirement.

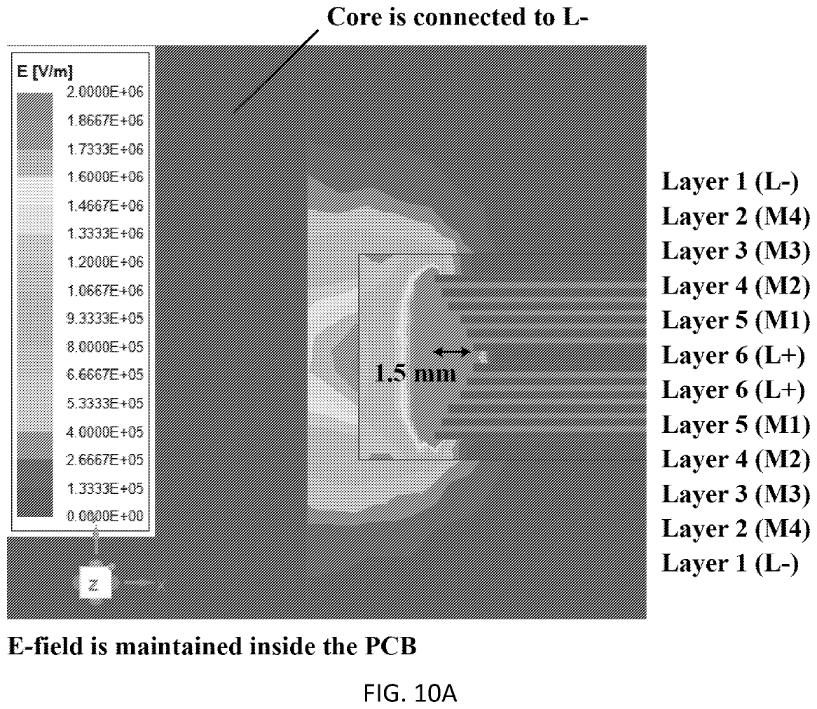

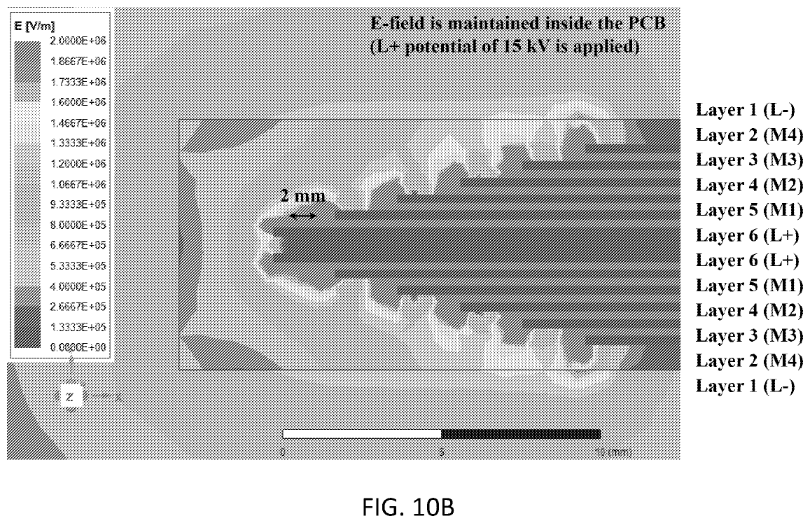

FIGS. 5B and 5C focus on the region where an edge of the central layers of windings 310 are protruded outward to form a winding extension 340 as shown in FIG. 3 for providing the necessary connection to a terminal (e.g., second terminal 302). A high electric field around this region may exceed the breakdown voltage of air and lead to partial discharges. To prevent such a strong electric field, an electric field limiting technique (such as staggering) is applied in this region of winding extension 340. Because different winding layers of inductor 300 are at a different voltage due to the voltage gradient across windings 310 as shown in FIG. 4, individual layers are extended to form an equipotential surface on each layer, and these extensions are designed in a certain way to limit the electric field in the region. In one embodiment, lateral sides of winding extension 340 are arranged in a “concave” staggered pattern as shown in FIG. 5B, while a frontal side of winding extension 340 is arranged in a “convex” staggered pattern as shown in FIG. 5C. FIGS. 10A and 10B respectively illustrate computer simulated results of electric field distribution at a peak voltage of 15 kV for the winding layers of a PCB-based inductor arranged in “concave” and “convex” staggered patterns.

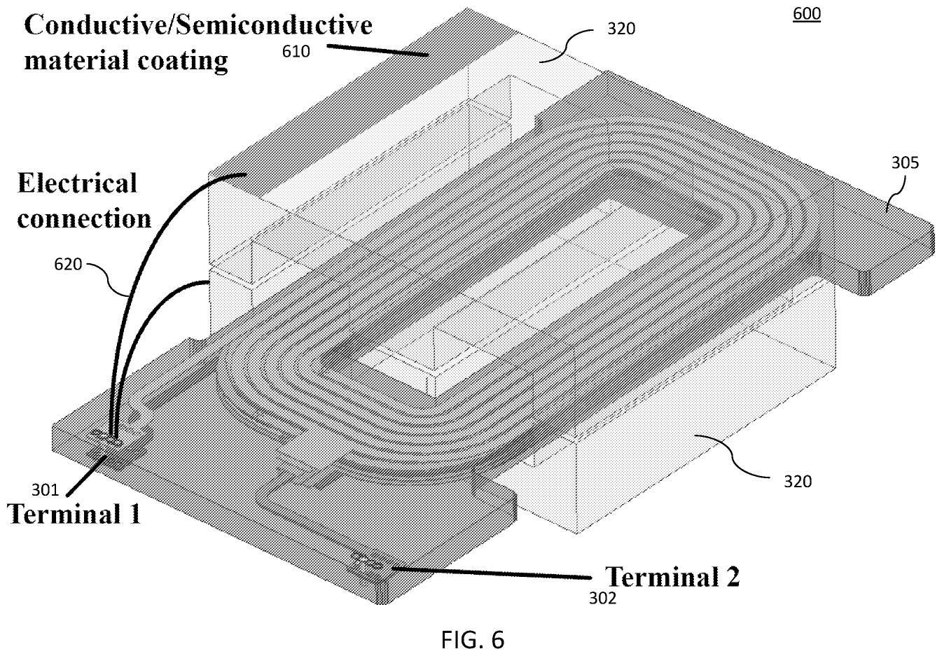

FIG. 6 illustrates a PCB-based medium voltage inductor 600 in accordance with another embodiment of the present disclosure. Inductor 600 in FIG. 6 is substantially identical to inductor 300 in FIG. 3, except that magnetic core 320 is coated with a layer 610 of conductive or semiconductive material. In addition, electrical connection 620 is required between magnetic core 320 and one of the terminals (e.g., first terminal 301), because the staggered winding structure as shown in FIG. 5 can alleviate the electric field in the air to less than the air breakdown voltage only if magnetic core 320 is connected to one of the terminals. In certain embodiments, electrical connection 620 can be made using a conducting wire or a metal bar. The conducting/semiconducting coating on the surface of magnetic core 320 can provide a reliable connection for maintaining the potential of magnetic core 320. It should be noted that the connection should be made to both components of magnetic core 320. The choice of the terminal to which magnetic core 320 can be connected is not arbitrary. In one embodiment, magnetic core 320 should be connected to the terminal closest to the outer surface of PCB 305 (e.g., first terminal 301).

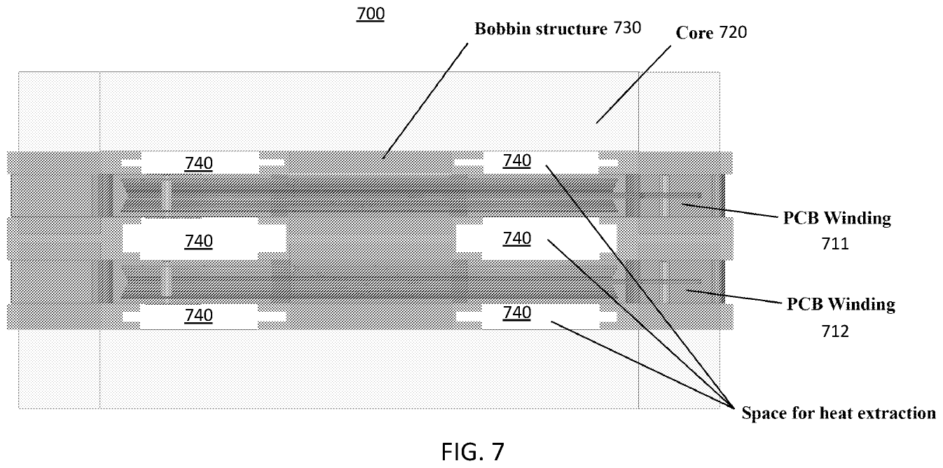

FIG. 7 illustrates a cross-sectional view of a medium voltage inductor 700 that uses a bobbin structure 730 to hold a plurality of PCB windings 711 and 712 and a magnetic core assembly 720 in accordance with an embodiment of the present disclosure. Bobbin structure 730 can be coated with a semi-conductive or conductive surface and can be electrically connected to magnetic core assembly 720 so that they share the same potential. Also, because inductor 700 is a potting-less solution, the remaining window areas 740 can be used for forced air cooling solution to directly remove the heat generated from PCB windings 711 and 712. Alternatively, a thermally conductive material, such as, aluminum nitride, can be coupled to PCB windings 711 and 712 with some thermal interface material to remove heat using heatsinks disposed on the thermally conductive material at a distance from inductor 700.

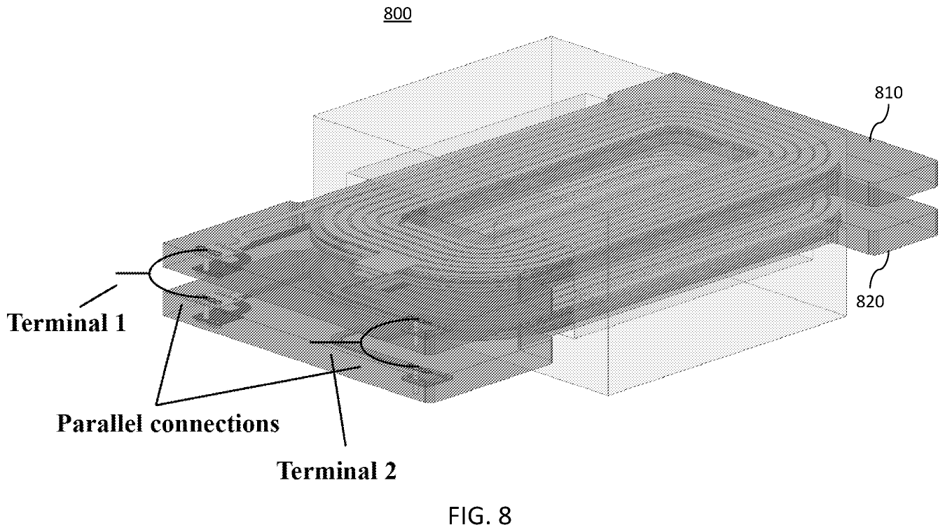

FIG. 8 illustrates a medium voltage PCB-based inductor assembly 800 including two identical PCB-based windings 810 and 820 connected in parallel in accordance with an embodiment of the present disclosure. As shown, first terminals of PCB-based windings 810 and 820 are connected to each other, and second terminals of PCB-based windings 810 and 820 are similarly connected. Paralleling two PCB-based windings reduces the current through each of the PCB-based winding, and thus can help to reduce the total winding losses. However, more PCB-based windings connected in parallel would require a larger window area, which increases the volume of the magnetic core as well as the overall size of the inductor. Optimization is required to establish the appropriate quantity of parallelly connected PCB windings for the desired medium voltage inductor.

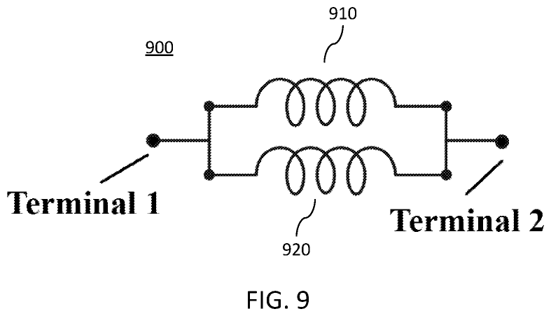

FIG. 9 illustrates an equivalent circuit 900 for two parallelly connected PCB-based windings 910 and 920 in accordance with an embodiment of the present disclosure. More quantity of PCB-based windings can be connected in parallel depending on the window area available and/or required, which can help in reducing the total winding loss for the medium voltage inductor.

Although various embodiments of the present disclosure have been described in detail herein, one of ordinary skill in the art would readily appreciate modifications and other embodiments without departing from the spirit and scope of the present disclosure as stated in the appended claims.

1. A PCB-based inductor, comprising:
an insulating planar board having a central through hole;
a plurality of conductive layers embedded in the insulating planar board and stacked on top of each other, the conductive layers being electrically connected with each other through one or more buried vias, each of the conductive layers being patterned to have a spiral shape around the central through hole and arranged in an annulus region having an annular radius;
a first terminal electrically coupled to outermost ones of the conductive layers; and
a second terminal electrically coupled to a centermost one of the conductive layers;
wherein the conductive layers are arranged in a staggered pattern.

2. The inductor of claim 1, wherein the staggered pattern is a concave staggered pattern.

3. The inductor of claim 2, wherein the concave staggered pattern is defined such that the annular radius of the conductive layers increases from the centermost one of the conductive layers to the outermost ones of the conductive layers.

4. The inductor of claim 1, further comprising a winding extension protruding from an edge of the conductive layers.

5. The inductor of claim 4, wherein the second terminal is electrically coupled to the centermost one of the conductive layers through the winding extension.

6. The inductor of claim 4, wherein lateral sides of the winding extension are arranged in a concave staggered pattern, and wherein a frontal side of the winding extension is arranged in a convex staggered pattern.

7. The inductor of claim 1, wherein the conductive layers are spatially separated in a vertical direction.

8. The inductor of claim 1, further comprising a magnetic core magnetically coupled to the conductive layers.

9. The inductor of claim 8, wherein the magnetic core is electrical connected to the first terminal.

10. The inductor of claim 9, further comprising a conducting or semiconducting layer coated on a surface of the magnetic core, wherein the magnetic core is electrical connected to the first terminal through the conducting or semiconducting layer.

11. A medium voltage inductor assembly, comprising:
a plurality of the PCB-based inductors according to claim 1;
a bobbin structure that holds the PCB-based inductors; and
a magnetic core assembly magnetically coupled to the PCB-based inductors.

12. A medium voltage inductor assembly, comprising a plurality of the PCB-based inductors according to claim 1, wherein the first terminals of the PCB-based inductors are electrically connected to each other, and wherein the second terminals of the PCB-based inductors are electrically connected to each other.

13. A PCB-based inductor, comprising:
an insulating planar board having a central through hole;
a plurality of conductive layers embedded in the insulating planar board and stacked on top of each other, the conductive layers being electrically connected with each other through one or more buried vias, each of the conductive layers being patterned to have a spiral shape around the central through hole and arranged in an annulus region having an annular radius;
a first terminal electrically coupled to outermost ones of the conductive layers; and
a second terminal electrically coupled to a centermost one of the conductive layers;
wherein the annular radius of the conductive layers increases from the centermost one of the conductive layers to the outermost ones of the conductive layers.

14. The inductor of claim 13, further comprising a winding extension protruding from an edge of the conductive layers.

15. The inductor of claim 14, wherein the second terminal is electrically coupled to the centermost one of the conductive layers through the winding extension.

16. The inductor of claim 14, wherein lateral sides of the winding extension are arranged in a concave staggered pattern, and wherein a frontal side of the winding extension is arranged in a convex staggered pattern.

17. A PCB-based inductor, comprising:
an insulating planar board having a central through hole;
a plurality of conductive layers embedded in the insulating planar board and stacked on top of each other, the conductive layers being electrically connected with each other through one or more buried vias, each of the conductive layers being patterned to have a spiral shape around the central through hole and arranged in an annulus region having an annular radius;
a winding extension protruding from an edge of the conductive layers;
a first terminal electrically coupled to outermost ones of the conductive layers; and
a second terminal electrically coupled to a centermost one of the conductive layers through the winding extension;
wherein the annular radius of the conductive layers increases from the centermost one of the conductive layers to the outermost ones of the conductive layers.

18. The inductor of claim 17, wherein lateral sides of the winding extension are arranged in a concave staggered pattern.

19. The inductor of claim 17, wherein a frontal side of the winding extension is arranged in a convex staggered pattern.
